(19) United States
(12) Patent Application Publication
(10) Pub. No.: US 2013/0300657 A1
(43) Pub. Date: Nov. 14, 2013

(54) USER REPLACEABLE CASE FOR TOUCH OPERATED HANDHELD DEVICE

(71) Applicant: Gerhard Podhradsky, Deutsch Wagram (AT)

(72) Inventor: Gerhard Podhradsky, Deutsch Wagram (AT)

(73) Assignee: SPEECH PROCESSING SOLUTIONS GMBH, Wien (AT)

(21) Appl. No.: 13/874,538

(22) Filed: May 1, 2013

Related U.S. Application Data
(60) Provisional application No. 61/643,920, filed on May 8, 2012.

(51) Int. Cl. G06F 3/0362

(52) U.S. Cl. CPC G06F 3/0362
USPC 345/157

(57) ABSTRACT

A user replaceable case for a touch operated handheld device, the case being arranged for at least partially enveloping the device when the case is applied to the device, the case comprising a device interface for digitally interfacing with the device when the case is applied to the device; a physical control means arranged on an outer surface of the case for providing tactile feedback to a user when operating the physical control means; and a controller for i) sensing an operation of the physical control means by the user, and ii) based on the operation, sending an instruction to the device via the device interface for controlling the device.

### CROSS REFERENCE TO RELATED APPLICATION

The present application claims the benefit of U.S. Provisional Application No. 61/643,920 filed on May 8, 2012, the entire disclosure of which is incorporated by reference herein.

### FIELD OF THE INVENTION

The invention relates to a user replaceable case for a touch operated handheld device. The invention further relates to the touch operated handheld device having the case applied, and to a computer program product comprising program instructions constituting an application when loaded on the touch operated handheld device.

Handheld devices are electronic devices with a form factor which is typically small enough to be held and operated by hand. Such devices frequently comprise batteries for being operational without having to be connected to an electrical power socket. Examples of handheld devices include, e.g., the mobile phone, GPS navigation unit, etc.

Such handheld devices are frequently arranged to be operable by touch. Here, the term operable by touch refers to the device being arranged for detecting a presence of a touch of, e.g., a user's finger, on a touch sensitive surface of the device. Thus, instead of the user pressing physical buttons or toggling physical switches arranged on the handheld device, the user is able to operate the handheld device by touching the touch sensitive surface. The touch sensitive surface may be formed by a display of the handheld device, i.e., the display may be a touch sensitive display, also referred to as touch screen. Alternatively, the touch sensitive surface may be provided on a bezel or other surface of the device. Examples of touch operated handheld devices include, e.g., the Smartphone, tablet device, etc.

### BACKGROUND OF THE INVENTION

The main form of interaction with the aforementioned touch operated handheld devices is by touch. For example, in case the touch operated handheld device is a Smartphone comprising a touch sensitive display, the user may predominantly control the Smartphone by touching certain locations on the display. Although such a device may still comprise physical buttons, the physical buttons frequently only enable limited control of the device, i,e., enable a user to turn the device on or off, adjust a speaker volume, etc.

It is known to facilitate the touch based interaction by displaying a graphical representation of a control means at appropriate locations of a touch sensitive display. The graphical representation may be of a button, slider, etc. Hence, a user can identify which locations of the touch sensitive display need to be touched to effect the control. Moreover, it is known to provide a visual indication of the type of control which is effected by touching the graphical representation. For example, a text or a symbol indicative of the type of control effected may be displayed with, or as part of, the graphical representation. For example, a dictation application termed “SpeeehExec dictation recorder for iPhone”, arranged for running on an Apple iPhone, and as described in a user manual obtained from http://www.dictation.philips.com/products-solutions/product/speechexec_dictation_recorder_for_iphone/support/ on Mar. 28, 2012, provides a dictation functionality. It is said that the application provides easy-to-use touch screen control for intuitive operation. The display shows all recording functions, and the main interface allows the user to record and navigate within recordings.

### SUMMARY OF INVENTION

A problem of the touch operated handheld device is that a user cannot easily control the device while being concentrated on other matters.

It would be advantageous to have means enabling a user to easily control the touch operated handheld device while being concentrated on other matters.

To better address this concern, a first aspect of the invention provides a user replaceable case for a touch operated handheld device, the case being arranged for at least partially enveloping the device when the case is applied to the device, the case comprising:
a device interface for digitally interfacing with the device when the case is applied to the device;
a physical control means arranged on an outer surface of the case for providing tactile feedback to a user when operating the physical control means; and
a controller for i) sensing an operation of the physical control means by the user, and ii) based on the operation, sending an instruction to the device via the device interface for controlling the device.

In a further aspect of the invention, a touch operated handheld device is provided, the touch operated handheld device having the case applied as set forth.

The aforementioned measures provide a case for a touch operated handheld device. The touch operated handheld device is a device which is normally operated by touch. The case at least partially wraps around or covers the device while still enabling the device to be operable by touch, i.e., without substantially affecting the device's touch operability. The case is user replaceable, in that the case is not an integral part of the device but rather a separate component which may be applied and removed by the user. The case comprises a device interface which enables the case to communicate with the device. For that purpose, the device interface may be connectable to an external interface of the device.

The case further comprises a physical control means, i.e., a control means which is physically operable. Hence, the control means is not operable by touch alone, but rather requires the user to move, press, slide, etc. the control means, As a result, a physical action is needed of the user, with the physical action inherently also providing tactile feedback to the user, i.e., a mechanical stimulation to the user's fingers or thumb when operating the physical control means. This mechanical stimulation conveys the user information on the past or present state of the physical control means. For example, the resistance encountered while pressing a button may provide the user with tactile feedback on whether the button has been sufficiently depressed or had been previously depressed. Similarly, when starting to operate a slider having multiple fixed positions, a user may feel a current position of the slider, thus being provided with tactile feedback on its current position. Moreover, when operating the slider, the user may feel whether the slider has been sufficiently moved to fixate the slider into another one of the fixed positions. The physical control means is located on an outer side of the case for being accessible to the user. It is noted that the inner side of the case is typically in direct contact with the device.

The device further comprises a controller for sensing the user operating the physical control means. For example, the controller may sense when a button is pressed and when a button is released. Similarly, the controller may sense when a slider is moved in a certain position. The sensing may be electronically, optically, etc, The controller is arranged for sending an instruction to the device via the device interface, i.e., in a digital form, with the instruction being provided in dependence on the sensed operation of the user. The instruction, when received by the device, is considered by the device as a command. The user can thus control the device by operating the physical control means of the case.

The invention is partially based on the recognition that touch operated handheld devices are widely adopted by consumers and professionals alike, in parts due to the fact that their touch based operation is convenient in many situations. However, some situations exist in which touch based operation is not convenient to a user. In particular, when the user is concentrated on other matters, touch based operation may be inconvenient due to the fact that a user typically has to look at the touch sensitive surface to determine where it needs to be touched in order to effect a command. Hence, it is difficult to operate the touch sensitive surface without consciously looking at the touch sensitive surface.

An example of such a situation is dictation using a dictation application running on a Smartphone, A user typically desires to control recording functions during the dictation, e.g., by starting, pausing or stopping recordings. The dictation application typically offers such control by providing graphical representations of buttons on the touch screen.

The inventors have recognized that it is practically impossible to operate such an application blindly during dictation. A reason for that is that in between different control operations, the user needs to lift the finger and hover over the touch screen to avoid unintended activations. Moreover, to change between different recording functions, the user needs to look to the touch screen in order to strike the right button on the touch screen. The inventors have recognized that while operating a device in the above manner may be acceptable for short periods of time, it is not convenient for longer periods of time.

The measures according to the present invention provide a user replaceable case for a touch operated handheld device. The case comprises a physical control means. By applying the case to the device, the user can therefore also apply the physical control means to the device. Essentially, the physical control means becomes affixed to the device. Since the case is arranged for at least partially enveloping the device when the case is applied to the device, the case and thus its physical control means can be well attached to the device, i.e., in a stable manner. By providing the physical control means on an outer surface of the case, the physical control means is easily accessible to the user. Moreover, since the physical control means provides tactile feedback to a user when operating the physical control means, the user can conveniently operate the physical control means even when being concentrated on other matters. Advantageously, the user may operate the physical control means blindly.

By providing a device interface for digitally interfacing with the device, and a controller for sensing an operation of the physical control means by the user, and based on the operation, sending an instruction to the device via the device interface, a mechanical operation of the physical control means is measured and used to send a specific instruction in a digital form via the device interface to the device. As a result, when the case is applied to the touch operated handheld device, the user can, by operating the physical control means, conveniently control the device even when being concentrated on other matters. Advantageously, the user can control the device blindly, i.e., without looking.

Advantageously, the case can, in addition to functioning as an attachment means for enabling the physical control means to attach to the device, also function as device protection.

It is noted that it is known to manufacture a touch operated handheld device which includes a physical sliding switch as an integral part of the device. For example, US 2008/0146275 A1 describing a combination device of a dictating device and a Smartphone in which a physical sliding switch is provided on a side of the combination device.

However, the inventors have recognized that touch operated handheld devices are widely adopted by consumers and professionals alike in part due to the fact that their touch based operation is convenient in many situations, and that physical control means may only be needed in specific situations and/or by specific users. The aforementioned combination device addresses the latter situations, but reduces the convenience in the former situations, e.g., by the physical sliding switch increasing the size of the device, distorting an otherwise astatically pleasing form of the device, etc. By providing a user replaceable case, the physical control means may be attached to the touch operated handheld device in said specific situations and/or by said specific users. Advantageously, a user may remove the case when the physical control means is not needed. Advantageously, the user may apply the case to a pre-existing touch operated handheld device to enable its physical control.

Optionally, the physical control means is positioned on the outer surface of the case for being operable by thumb when the user is holding the device at its default orientation. Operating a physical control means by thumb is convenient, in particular when the user is holding the device with one hand. In such a situation, the thumb is typically still relatively free to move and therefore able to operate the physical control means. Advantageously, users that are accustomed to devices being operable by thumb can continue operating this way with the touch operated handheld device having the case applied.

Optionally, the controller is arranged for generating the instruction based on an application interface specification for controlling an application running on the device. Nowadays, many touch operated handheld devices are arranged for running software application which allow the user to perform specific tasks, i.e., so-termed ‘Apps’. These applications typically provide additional functionality compared to the functionality offers by the device's system software. The case is arranged for enabling the user to control such an application running on the device by operating the physical control means.

Optionally, the application is a dictation application, and wherein the controller is arranged for generating the instruction for controlling a dictation functionality of the dictation application. Dictation is an activity which benefits especially from the present invention, in that the user is typically fully concentrated on the subject matter of the dictation.

Optionally, the physical control means comprises a slide switch. A slide switch is a switch in which the switch is moved, i.e., switched, by sliding the switch. Such operation is well suited for receiving tactile feedback while operating the slide switch. Moreover, slide switches are used as physical control means on many non-touch operated handheld devices, e.g., dictation devices. By providing a slide switch as physical control means on the case, the manner of operating of the touch operated handheld device having the case applied is immediately familiar to users of the non-touch operated handheld devices.

Optionally, the slide switch is a four position slide switch for enabling the user to send, using the controller, one of at least four different instructions to the device by moving the slide switch into one of its four positions. The physical control means thus enables a user to control different aspects or functionality of the device by suitably moving the slide switch into different positions. Advantageously, four position slide switches are immediately familiar to users of non-touch operated professional dictation recorders.

Optionally, the slide switch comprises at least one detent for fixating the slide switch in one of two middle positions upon release by the user, and at least one resilient part for enabling the slide switch to spring back from an end position to the one of the two middle positions upon release by the user.

Optionally, the case and/or the physical control means comprises a visual indication of the control effected on the device as a result of operating the physical control means. Hence, the user can obtain visual information on the type of control effected on the device by glancing on the case and/or the physical control means. Advantageously, the visual indication provides guidance to a user while learning to operate the physical control means blindly, which may then be disregarded after having learned said operating blindly.

Optionally, the visual indication is indicative of at least one of a: record, playback, stop, fast forward, and fast rewind, command.

Optionally, the device interface comprises a physical connector for digitally interfacing with the device via the physical connector.

Optionally, the physical connector is arranged for receiving electrical energy from the device for electrically powering the case. Hence, the physical connector servers both for digitally interfacing with the device as well as powering, e.g., the controller.

Optionally, the device interface comprises a wireless interface for wirelessly interfacing with the device.

Optionally, the case is arranged for being applied to a Smartphone.

A further aspect of the invention provides a computer program product comprising program instructions, the program instructions constituting an application when loaded on a touch operated handheld device, and the application being arranged for receiving an instruction from a user replaceable case according to claim I being applied to the touch operated handheld device for enabling a user to control the application by operating the physical control means of the case. The application is thus arranged for being controlled by the user operating the physical control means of the case when applied to the device.

Optionally, the application is a dictation application arranged for receiving the instruction from the case for enabling the user to control a dictation functionality of the dictation application.

It will be appreciated by those skilled in the art that two or more of the above-mentioned embodiments, implementations, and/or aspects of the invention may be combined in any way deemed useful.

Modifications and variations of the image processing system, the image device, the handheld device, the workstation, the imaging apparatus, the method, and/or the computer program product, which correspond to the described modifications and variations of the image processing system, can be carried out by a person skilled in the art on the basis of the present description.

The invention is defined in the independent claims. Advantageous embodiments are defined in the dependent claims.

### BRIEF DESCRIPTION OF THE DRAWINGS

These and other aspects of the invention are apparent from and will be elucidated with reference to the embodiments described hereinafter. in the drawings,

FIG. 1a shows a user replaceable case according to the present invention.

FIG. 1b shows a cross-sectional view of the case;

FIG. 2a shows the case being applied to a touch operated handheld device;

FIG. 2b shows a cross-sectional view of the case being applied to the device;

FIG. 3 shows a screenshot of a dictation application for a Smartphone;

FIG. 4a shows a close-up view of a four-position slide switch of the case;

FIG. 4b shows a top close-up view of the four-position slide switch;

FIG. 5a shows a smaller variant of the user replaceable case according to the present invention, the case being arranged for wirelessly interfacing with the device; and

FIG. 5b shows the case being applied to the device.

### DETAILED DESCRIPTION OF EMBODIMENTS

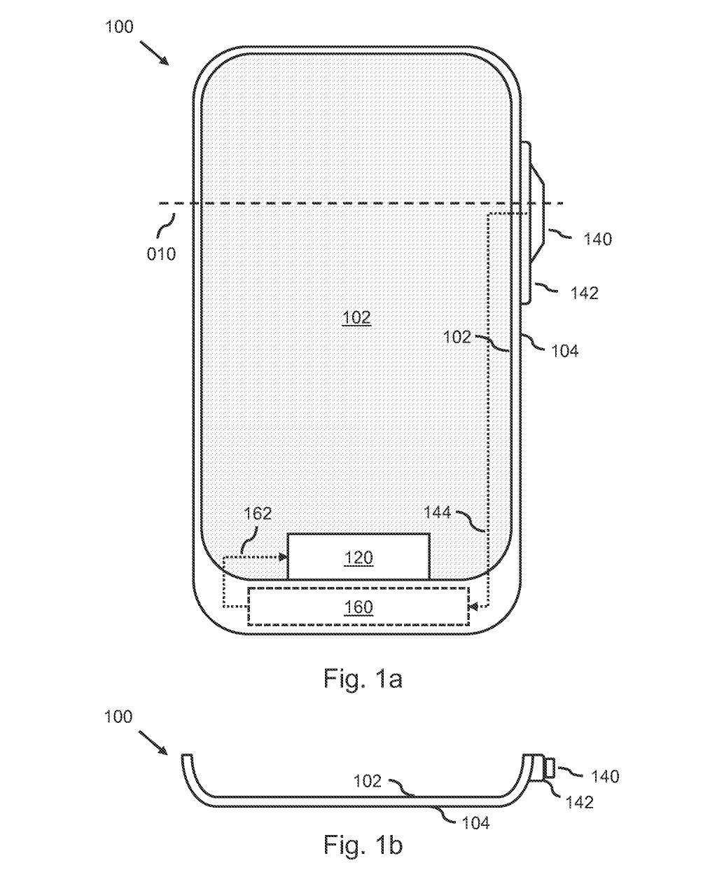

FIGS. 1a and 1b both show an example of a user replaceable case 100 according to the present invention, also referred to as case 100. FIG. 1a shows a frontal view of the case 100, whereas FIG. 1b shows a cross-sectional view of the case 100 corresponding to the cross-sectional plane as indicated in FIG. 1a by the coarsely dashed line 010. It is noted that a reference to FIG. 1 is to be understood as jointly referring to FIGS. 1a and 1b.

The case 100 is arranged for being applied to a touch operated handheld device, also referred to as device. The touch operated handheld device is not shown in FIG. 1, i.e., FIG. 1 rather shows the case 100 before being applied to the device. The case 100 is arranged for at least partially enveloping the device when the case 100 is applied to the device. As such, the case 100 is suitably shaped. In the example of FIG. 1, the case 100 is shown to form a concavity with its inner surface 102 into which the device fits when being placed therein. The concavity is illustrated in FIG. 1a by the dashed portions of the case 100, with FIG. 1b more clearly showing the concavity. In general, the shape of the case 100 may be such that the case 100 substantially self-attaches to the device, e.g., snaps or clicks onto or around the device. Alternatively, the case 100 may comprise attachment means such as an adhesive or magnetic surface which enables or improves the attachment to the device.

The case 100 comprises a physical control means 140 arranged on an outer surface 104 of the case. FIG. 1 shows the physical control means 140 being a slide switch 140. The slide switch 140 is shown to be arranged on an upper-right location of the case 100. The case 100 further comprises a device interface 120. The device interface 120 is arranged for digitally interfacing with the device when the case 100 is applied to the device. In the example of FIG. 1, the device interface 120 is shown to constitute a physical connector 120. However, the device interface 120 may also comprise additional components or no physical connector at all. The case 100 further comprises a controller 160. The controller 160 is arranged for sensing an operation of the physical control means 140 by the user. In the example of FIG. 1, the controller 160 is shown to be connected to the slide switch 140 for receiving an operation signal 144 from the slide switch 140. The operation signal 144 is indicative of said operation by the user. The controller 160 is further arranged for, based on the operation, sending an instruction 162 to the device via the device interface 120. For that purpose, the controller 160 is shown to be connected to the device interface 120.

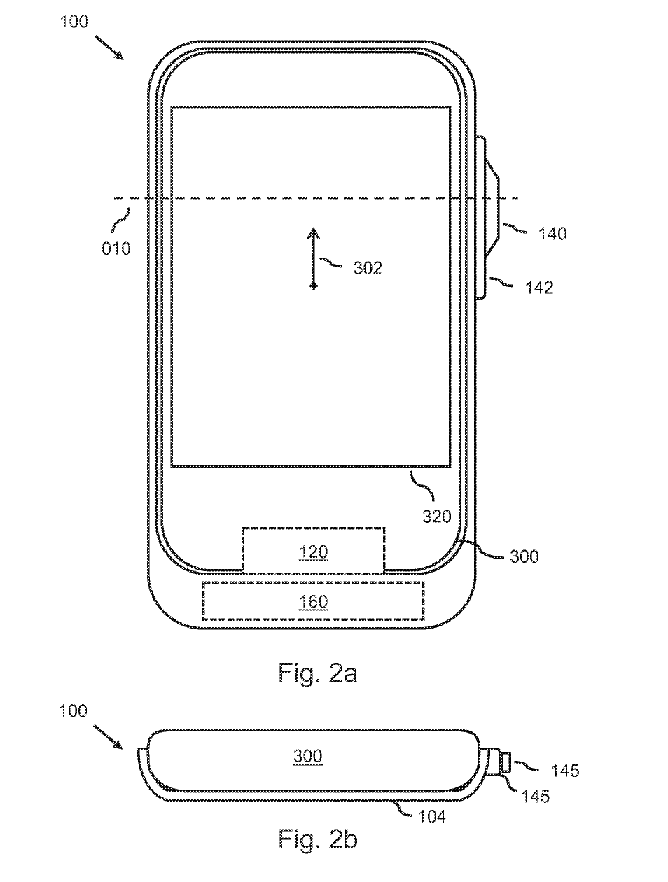

FIGS. 2a and 2b show the case 100 being applied to a touch operated handheld. device 300. Similarly as with FIG. 1, FIG. 2a shows a frontal view of the case 100, whereas FIG. 2b shows a cross-sectional view of the case 100 corresponding to the cross-sectional plane as indicated in FIG. 2a by the coarsely dashed line 010. Moreover, it is noted that a reference to FIG. 2 is to be understood as jointly referring to FIGS. 2a and 2b.

The case 100 being applied to the device 300 may involve the device 300 being inserted into the concavity formed by the inner surface 102 of the case 100. As a result, FIG. 2 shows the device 300 fitting into the concavity. It is noted, however, that other means of applying the case 100 to the device 300 may be equally suitable. For example, the device 300 may be slid into the case 100, the case 100 may be clicked onto the device 300, etc.

The physical connector 120 may be positioned such with respect to the case 100 that, upon applying the case 100 to the device 300, the physical connector 120 is automatically inserted into a corresponding physical socket of the device 300 or automatically contacts a corresponding physical connector of the device 300. In the example of FIG. 2, the device 300 comprises a physical socket into which the physical connector 120 of the case 100 is inserted upon inserting the device 300 into the cavity formed by the inner surface 102 of the case. It is noted that the physical socket of the device 300 is not shown in FIG. 2. due to its occlusion by the front side of the device 300. Instead, the physical socket 120 is represented by means of a dashed line to indicate its insertion into the device 300. The physical socket of the device 300 may correspond to the portions of the device 300 fitting around the physical connector 120 when being inserted into the device 300.

The operation of the case 100 may be explained by way of the following examples. The device 300 may be a touch operated handheld device which is exclusively or predominantly operated using a touch sensitive surface 320. The touch sensitive surface 320 may be formed by or be part of a touch screen 320. The device 300 may be a Smartphone such as an Apple iPhone or similar device. Upon applying the case 100 to the device 300, the user is presented with a case 100 being well attached to the device 300, i.e., in a stable manner. The user may thus hold or handle the device 300 by holding or handling the case 100. The device 300 may be arranged for being held by a user's single hand, e.g., fitting into a user's palm and capable of being held between the user's fingers at a left side of the device 300 and the user's thumb at a right side of the device 300. Upon applying the case 100 to the device 300, the user may hold the case 100 accordingly, i.e., in a similar manner.

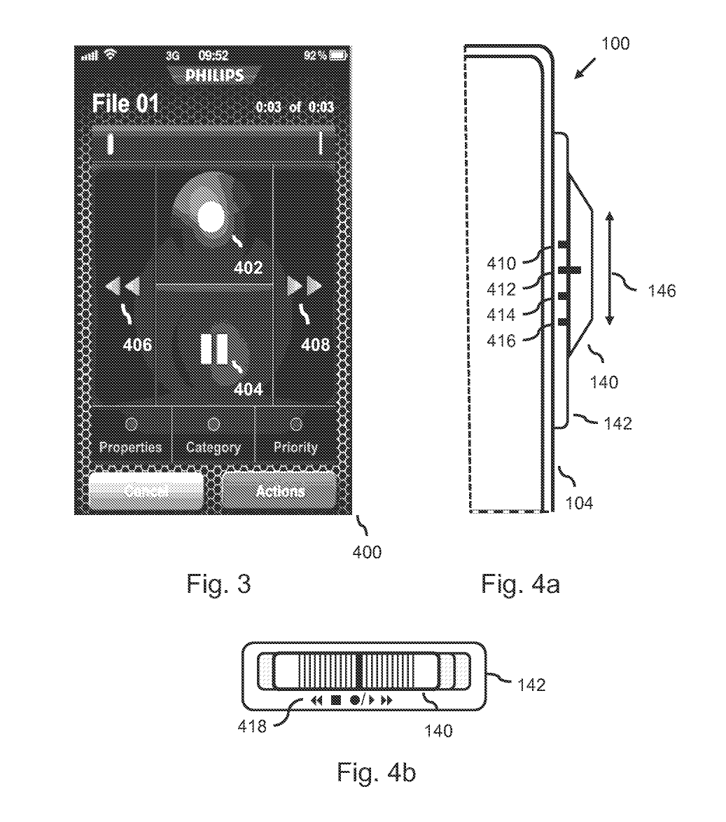

A certain functionality of the device 300 may be operable by touch, e.g., a dictation functionally provided by a dictation application running on the device 300. FIG. 3 shows an example of such a dictation application 400. Here, a screenshot is shown of the dictation application “SpeechExec dictation recorder for iPhone” arranged for running on an Apple iPhone. The screenshot shows touch control means 402-408 for being displayed on the touch screen 320 which, when touched by the user, control the dictation functionality of the dictation application 400. The touch control means 402-408 provide a visual indication of the control effected on the device 300 as a result of touching the touch control means. For example, touching a record symbol 402 triggers recording, i.e., a start or continuation of a dictation, a pause symbol 404 causes the recording to be paused, a fast rewind symbol 406 causes the recording to be fast rewound and a fast forward symbol 408 causes the recording to be fast forwarded. Hence, a user may control the dictation functionality of the dictation application 400 by touching selected portions of the touch screen 320.

The case 100 provides the user with a physical control means 140. FIGS. 1 and 2 show the physical control means 140 being positioned on the outer surface of the case 100 such that the physical control means 140 is operable by thumb when the user is holding the device 300 at its default orientation 302. Here, the default orientation 302 is a portrait orientation 302 of the device 300. The term default orientation refers to a normally used orientation of the device, e.g., corresponding to its primary or traditional usage. Hence, the user may conveniently operate the physical control means 140 by thumb.

In summary, FIGS. 1 and 2 show a case 100 arranged for enveloping the back side of the device 300 while keeping clear of the touch screen 320. The physical control means 140 is arranged on a side of the device 300 when viewed frontally, at a vertical position in which it is operable by thumb when the user holds the device 300.

The user may operate the dictation functionality on the device 300 as follows. Instead of touching the record symbol 402 on the touch screen 320 to trigger recording, the user may operate the physical control means 140. For example, in case the physical control means 140 is the slide switch 140 as shown in FIGS. 1 and 2, the user may trigger recording by sliding the slide switch 140 to a recording position. Upon sliding the slide switch 140, the user is provided with tactile feedback, e.g., by the slide switch 140 locking into the recording position and thus providing tactile feedback to the user that the slide switch 140 has been sufficiently slid to reach the recording position. The controller 160 of the case 100 may sense the user's operation of the slide switch 140. For that purpose, the case 100, the physical control means 140 and/or the controller 160 may be provided with a sensor, e.g., an electrical or optical sensor which provides the operation signal 144. It is noted that the sensing function may also be integrated into the controller 160 itself and may be relatively simple so as not to be deemed a sensor. For example, the controller 160 may measure a resistance, with the slide switch 140 providing different resistances depending upon its position. Moreover, any other suitable means of sensing the operation of the slide switch 140 may be equally used.

After having determined that the slide switch 140 has been slid into the recording position, the controller 160 may issue an instruction 162 to the device 300 via the device interface 120. The instruction 162 may be arranged for triggering the recording functionality of the dictation application 400, which would otherwise involve the user needing to touch the recording symbol 402 on the touch screen 320. Moreover, as will be illustrated later, the above may apply to any dictation functionality of the dictation application 400, i.e., is not limited to the aforementioned recording functionality.

To issue the appropriate instruction 162 to the device 300, the controller 160 may be arranged for generating the instruction 162 based on an application interface specification. The application interface specification may specify which instructions correspond to which functionality of an application on the device 300. As such, the controller 160 may generate instructions for specifically controlling the dictation functionality 402-408 of the dictation application 400. It is noted that the instruction 162 sent by the case 100 may also correspond to a more generic signal, i.e., one which is not necessarily associated with the dictation application 400. For example, the instruction 162 may correspond to a signal being generated by the controller 160 for signaling the device 300 that ‘button A’ is pressed, with only the application 140 interpreting said signal as constituting an instruction 162 corresponding to a dictation functionality, e.g., for starting a recording.

Thus, the dictation application 400 may be arranged for interpreting a more generic signal as a specific instruction 162 for its functionality, e.g., by being appropriately programmed. Such programming may possibly be performed by the user, e.g., in a settings menu of the dictation application 400. Such settings menu may offer similar functionality to that of a learnable remote control which enables a user to associate infrared codes with device functionality. However, instead of associating infrared codes, the settings menu may enable associating generic signals received by the device 300 with specific device or application functionality. Alternatively or additionally, the user may select a type of case 100 or physical control means 140 to automatically program the application 400.

FIGS. 4a and 4b shows an example of a physical control means 140 comprising a four position slide switch 140. Here, operation of the physical control means involves sliding the slide switch 140 along a sliding direction 146 to position the slide switch 140 in any one of four different positions 410-416. The sliding direction 146 is illustrated in FIG. 4a with a bidirectional arrow. The four different positions 410-416 are illustrated in FIG. 4a by marks. FIG. 4b shows a top close-up view of the four position slide switch 140. In FIGS. 4a and 4b, henceforth jointly referred to as FIG. 4, the slide switch 140 is shown as being positioned in one of the two middle positions 412. Said position 412 may correspond to a playback/record functionality, e.g., the controller 160 may be arranged for issuing an instruction 162 to the device which causes the dictation application 140 to start a recording or a playback of the recording. For selecting between the two different functionalities, the physical control means 140 may further comprise a button (not shown in FIG. 1), with a state of the button, i.e., being either depressed or released, determining whether a recording or a playback is started upon sliding the slide switch 140 into the playback/record position. The two end positions 410, 416 of the slide switch 140 may correspond to fast forward and fast rewind functionality, respectively. The other one of the two middle positions 414 may correspond to stop functionality. Hence, a user may position the slide switch 140 in any one of the four different positions 410-416 to cause the controller 160 to send different instructions to the device 300 for controlling the dictation application 400. Essentially, the slide switch 140 may allow a user to control the dictation functionality of the dictation application 400 which is otherwise controllable by the touch control means 402-408. Hence, the user does not need to operate the touch control means 402-408 to control said functionality. It is noted, however, that the slide switch 140 may also provide other functionality, e.g., not being controllable by the touch control means 402-408.

The four position slide switch 140 may correspond to a slide switch known from existing dictation devices, i.e., devices solely or predominantly intended for dictation purposes. Such devices are known from vendors such as Philips, Grundig and Olympus, and typically comprise a four position slide switch. It is noted that although the physical slide switch may be similar between said vendors, the functionality effected in the different positions may differ. For example, a dictation device from Philips may provide, from one end position of the slide switch 410 to the other 416, fast rewind (FREW), stop (STOP), playback/record (PLAY/REC) and fast forward (FFWD) functionality. A dictation device from Grundig may instead provide fast rewind (FREW), playback/record (PLAY/REC), stop (STOP) and fast forward (FFWD) functionality. A dictation device from Olympus may instead provide fast rewind (FREW), playback (PLAY), stop (STOP) and record (REC) functionality. The slide switch 140 of the case 100 may be pre-configured for providing the functionality of one of the aforementioned vendors. The slide switch 140 may also enable the user to select one of the different functionalities, e.g., by operating a dipswitch or positioning the slide switch in a certain position during initialization. Alternatively or additionally, the dictation application 140 may enable the user to select the functionality of the slide switch 140, e.g., by selecting said functionality in a settings menu.

Similar to the four position slide switches known from pre-existing dictation devices, the slide switch 140 may comprise at least one detent for fixating the slide switch 140 in one of two middle positions 412, 414 upon release by the user, and at least one resilient part for enabling the slide switch to spring back from an end position 410, 416 to the one of the two middle positions upon release by the user. The resilient part may be a spring or similar part. For example, each of the two middle positions 412, 414 may comprise a detent for fixating the slide switch 140. Hence, when moving the slide switch 140 to a middle position 412 providing playback/record functionality, the slide switch 140 does not need to be further held by the user. Moreover, both of the end positions may comprise a resilient part such that a user needs to hold the slide switch 140 in either of the two positions to effect fast rewind or fast forward functionality. Upon release, the slide switch 140 may then spring back to an adjacent middle position, i.e., providing stop or playback/record functionality.

FIG. 4b shows a top close-up view of the slide switch 140. Here, visual indications 418 are shown of the control effected on the device 300 as a result of operating the slide switch 140. In the example of the four position slide switch 140, these visual indications 418 may correspond to fast rewind, stop, playback/record and fast forward functionality, respectively. The visual indications 418 may be provided on a base 142 of the slide switch 140, but may also be otherwise arranged on the case 100. It will be appreciated, however, that such visual indications 418 may also be omitted from the case 100, in particular when the functionality of the slide switch 140 is programmable.

Although not shown in any of FIGS. 1a-4b, the case 100 may be arranged for receiving electrical energy from the device 300 via the physical connector 120 in order to electrically power the case 100. Hence, the case 100 may not need a battery to function.

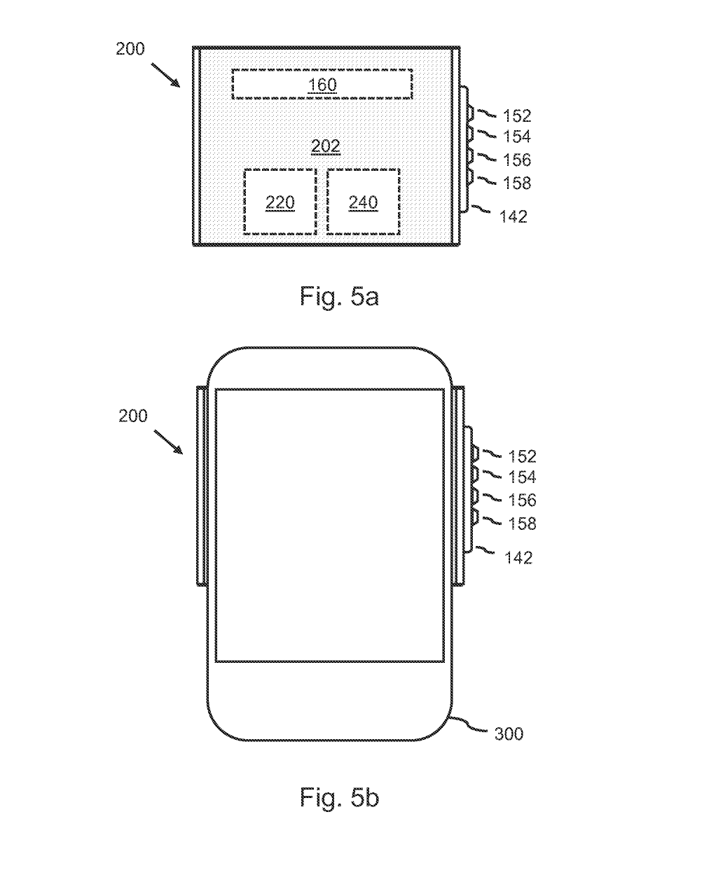

FIG. 5a shows a smaller variant of the user replaceable case 200 according to the present invention. The case 200 differs in part from the previously depicted case 100 in that the case 200 does not extend to the full height of the device 300. Rather, the case 200 is vertically reduced in size. However, similarly as the previously depicted case 100, the case 200 of FIG. 5a forms a concavity with its inner surface 202 into which a portion of the device 300 fits when being placed therein. The concavity is illustrated in FIG. 5a by the dashed portions of the case. The concavity may be similar or a same as that depicted in FIG. 1b. FIG. 5b shows the case 200 being applied to the device 300. Here, a portion of the back of the device 300 is enveloped by the case 200, yet with an approximately equally sized portion of the back of the device 300 remaining free of the case 200. Moreover, the front of the device 300 is substantially free of the case 200. It will be appreciated, however, that next to the aforementioned examples of the case 100, 200, many more shapes of the case are conceivable, e.g., enveloping more or less of the device, having different distributions between enveloping a front, back and sides of the device, etc. As such, any correspondences between the examples given are not to be understood as constituting limitations.

In addition to having a smaller size, the case 200 differs from the previously depicted case 100 in that the case 200 comprises a wireless interface 220 instead of a physical connector 120. The wireless interface 220 is arranged for wirelessly interfacing with the device 300. The wireless interface 220 may be arranged for wirelessly interfacing via Bluetooth, Zigbee, Near field communication, etc. For powering the wireless interface 220 and the controller 160, the case 200 is shown to comprise a battery 240. Hence, the case 200 is autonomously powered. For charging the battery 240, the case 200 may be arranged for inductive charging, e.g., via the device 300. Alternatively, instead of comprising a battery, the case 200 may be arranged for being inductively powered during operation.

The physical control means 140 is shown to comprise four consecutive buttons 152-156 instead of a four position slide switch. However, the four consecutive buttons 152-156 may offer functionality that is similar or a same as that of the four position slide switch. For example, a first button 158 may provide rewind functionality, a second button 156 may provide stop functionality, a third button 154 may provide playback/record functionality, and a fourth button 152 may provide fast forward functionality.

In general, the physical control means 140 may take any other suitable form. For example, the physical control means 140 may comprise buttons which may be individually pressed. The physical control means 140 may also comprise an arrangement of buttons in which only one of the buttons can be pressed at a same time, e.g., with the remaining buttons automatically releasing upon depressing of one of the buttons. The physical control means 140 may also comprise toggles, sliders, dials, etc.

It will be appreciated that the present invention is not limited to controlling a dictation functionality of a dictation application. Rather, the present invention may be equally applied to controlling other applications or to built-in functionality of the device. For example, the case may comprise a button which allows a user to start and stop a stopwatch running on the device. Hence, instead of having to operate touch control means to start or stop the stopwatch, the user may operate the physical button provided by the case.

It will be appreciated that the invention also applies to computer program products, particularly computer program products on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs.

For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g., Java interpreter instructions). Alternatively, one or more or all of the sub-routines may be stored in at least one external library file and linked with a main program either statically or dynamically, e.g., at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program product may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A user replaceable case for a touch operated handheld device, the case being arranged for at least partially enveloping the device when the case is applied to the device, the case comprising:
a device interface for digitally interfacing with the device when the case is applied to the device;
a physical control means arranged on an outer surface of the case for providing tactile feedback to a user when operating the physical control means; and
a controller for i) sensing an operation of the physical control means by the user, and ii) based on the operation, sending an instruction to the device via the device interface for controlling the device.

2. The case according to claim 1, wherein the physical control means is positioned on the outer surface of the case for being operable by thumb when the user is holding the device at its default orientation.

3. The case according to claim 1, wherein the controller is arranged for generating the instruction based on an application interface specification for controlling an application running on the device.

4. The case according to claim 3, wherein the application is a dictation application, and wherein the controller is arranged for generating the instruction for controlling a dictation functionality of the dictation application.

5. The case according to claim 1, wherein the physical control means comprises a slide switch.

6. The case according to claim 5, wherein the slide switch is a four position slide switch for enabling the user to send, using the controller, one of at least four different instructions to the device by moving the slide switch into one of its four positions .

7. The case according to claim 6, wherein the slide switch comprises at least one detent for fixating the slide switch in one of two middle positions upon release by the user, and at least one resilient part for enabling the slide switch to spring back from an end position to the one of the two middle positions upon release by the user.

8. The case according to claim 1, wherein the case and/or the physical control means comprises a visual indication of the control effected on the device as a result of operating the physical control means.

9. The case according to claim 8, wherein the visual indication is indicative of at least one of a: record, playback, stop, fast forward, and fast rewind, functionality.

10. The case according to claim 1, wherein the device interface comprises a physical connector for digitally interfacing with the device via the physical connector.

11. The case according to claim 10, wherein the physical connector is arranged for receiving electrical energy from the device for electrically powering the case.

12. The case according to claim 1, arranged for being applied to a Smartphone.

13. Touch operated handheld device having the case according to claim 1 applied.

14. Computer program product comprising program instructions, the program instructions constituting an application when loaded on a touch operated handheld device, and the application being arranged for receiving an instruction from a user replaceable case according to claim 1 being applied to the touch operated handheld device for enabling a user to control the application by operating the physical control means of the case.

15. Computer program product according to claim 14, wherein the application is a dictation application arranged for receiving the instruction from the case for enabling the user to control a dictation functionality of the dictation application.
